(19) United States
(12) Patent Application Publication
(10) Pub. No.: US 2016/0337245 A1
(43) Pub. Date: Nov. 17, 2016

(54) NETWORK ELEMENT CONTROLLER, AND CONTROL APPARATUS AND METHOD FOR CONTROLLING NETWORK ELEMENT CONTROLLERS

(71) Applicant: FUJITSU LIMITED, Kawasaki-shi (JP)

(72) Inventor: AKIKO YAMADA, Kawasaki (JP)

(73) Assignee: FUJITSU LIMITED, Kawasaki-shi (JP)

(21) Appl. No.: 15/146,262

(22) Filed: May 4, 2016

(30) Foreign Application Priority Data
May 14, 2015 (JP) 2015-098817

(51) Int. Cl. H04L 12/803; H04L 12/24; H04L 12/26

(52) U.S. Cl. CPC H04L 47/125; H04L 43/0888; H04L 41/12; H04L 43/0882

(57) ABSTRACT

A network element controller includes a processor. The processor is configured to control network elements included in a network. The network elements are assigned to the network element controller. The processor is configured to obtain attribute information for the respective network elements. The attribute information indicates a characteristic of throughput depending on communications between the network element controller and the respective network elements. The processor is configured to select a first network element from the network elements on basis of the obtained attribute information.

### CROSS-REFERENCE TO RELATED APPLICATION

This application is based upon and claims the benefit of priority of the prior Japanese Patent Application No. 2015-098817, filed on May 14, 2015, the entire contents of which are incorporated herein by reference.

### FIELD

The embodiment discussed herein is related to a network element controller, and a control apparatus and a method for controlling network element controllers.

### BACKGROUND

There has been attention focused on a software defined networking (SDN) technique to control the behavior of the entire network on the basis of software. As one of the techniques for realizing the SDN, a technique or protocol called OpenFlow (OF) (registered trademark) has been known.

Related techniques are disclosed in, for example, Japanese Laid-open Patent Publication No. 2013-30863 and Japanese Laid-open Patent Publication No. 2014-135614, and Japanese National Publication of International Patent Application No. 2014-502796.

In a network to which the OF is applied, multiple network devices (elements) are sometimes controlled by multiple controllers in a distributed manner. Here, even if an attempt is made to distribute the load among the controllers by simple load distribution control based on the load on the controllers, difficulty in removing load imbalance may hinder the convergence of the load distribution control.

### SUMMARY

According to an aspect of the present invention, provided is a network element controller including a processor. The processor is configured to control network elements included in a network. The network elements are assigned to the network element controller. The processor is configured to obtain attribute information for the respective network elements. The attribute information indicates a characteristic of throughput depending on communications between the network element controller and the respective network elements. The processor is configured to select a first network element from the network elements on basis of the obtained attribute information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a communication system according to an embodiment;

FIG. 2 is a diagram illustrating an exemplary operation of the communication system illustrated in FIG. 1;

FIGS. 3A and 3B are diagrams illustrating an exemplary load distribution control between controllers included in an OFC illustrated in FIG. 1;

FIGS. 4A and 4B are diagrams illustrating exemplary load distribution control between controllers included in the OFC illustrated in FIG. 1;

FIG. 5 is a diagram illustrating an exemplary configuration of the OFC illustrated in FIG. 1;

FIG. 6 is a flowchart illustrating an exemplary operation of the OFC illustrated in FIGS. 1 and 5;

FIGS. 7A and 7B are diagrams illustrating an example of calculation of load information for each of the controllers included in the OFC illustrated in FIG. 1;

FIG. 8 is a flowchart illustrating an exemplary operation of the OFC subsequent to FIG. 6;

FIG. 9 is a diagram illustrating an example of determination of disproportion in the number of switches to be managed illustrated in FIG. 8;

FIG. 10 is a flowchart illustrating an exemplary operation of the OFC subsequent to FIG. 8;

FIGS. 11A to 11C are diagrams illustrating an example of throughput information for each of the controllers included in the OFC illustrated in FIG. 1;

FIGS. 12A to 12C are diagrams illustrating an example of throughput information for each of the controllers included in the OFC illustrated in FIG. 1;

FIGS. 13A and 13B are diagrams illustrating examples of controller-to-switch correspondence information;

FIG. 14 is a flowchart illustrating an exemplary operation of the OFC illustrated in FIGS. 1 and 5;

FIG. 15 is a flowchart illustrating an exemplary operation of the OFC illustrated in FIGS. 1 and 5;

FIG. 16 is a flowchart illustrating an exemplary operation of the OFC illustrated in FIGS. 1 and 5;

FIG. 17 is a diagram illustrating a comparative example with the OFC illustrated in FIGS. 1 and 5;

FIG. 18 is a diagram illustrating a comparative example with the OFC illustrated in FIGS. 1 and 5;

FIG. 19 is a diagram illustrating a situation of concern in changing a manager of a switch;

FIG. 20 is a diagram illustrating types of switches managed by a controller; and

FIG. 21 is a diagram illustrating an exemplary hardware configuration of a computer.

### DESCRIPTION OF EMBODIMENT

Hereinafter, an embodiment is described with reference to the drawings. However, the embodiment described below is merely an example, and is not intended to exclude various changes or technical applications that are not specified below. Also, various exemplary aspects described below may be implemented in appropriate combination. Note that, in the drawings used in the following embodiment, components denoted by like reference numerals are like components unless otherwise noted.

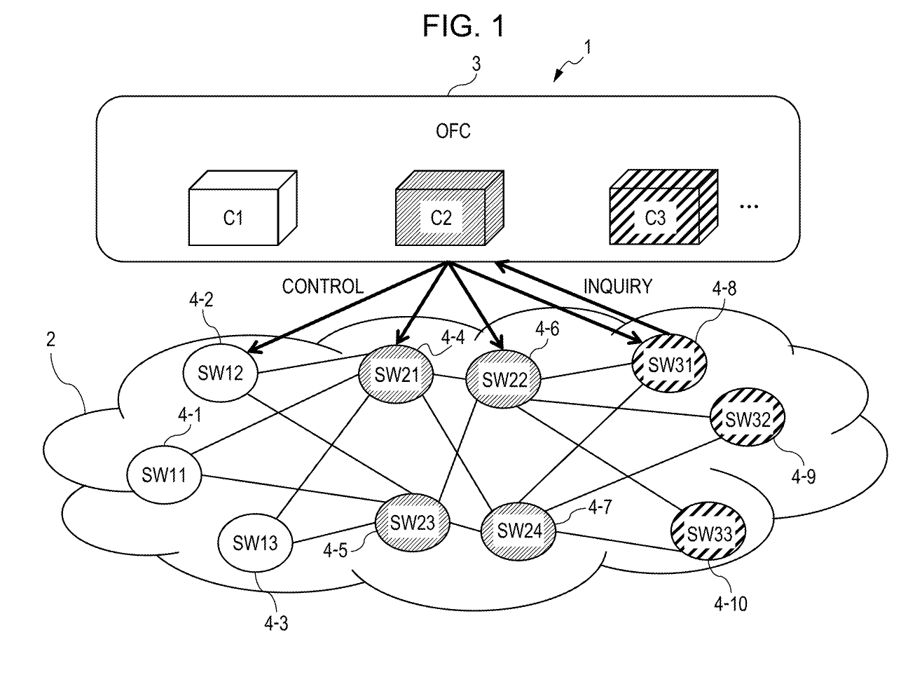

FIG. 1 is a diagram illustrating an exemplary configuration of a communication system according to an embodiment. A communication system 1 illustrated in FIG. 1 may include a network 2 and a network element controller 3 (or, simply a controller 3), for example.

For example, the network 2 may be a network configured to support the SDN, and the controller 3 may be an OpenFlow controller (OFC) configured to support an OpenFlow protocol (OFP). The OFC 3 is an example of a network controller.

The network 2 may include multiple network devices 4-1 to 4-N (N is an integer of 2 or more) as an example of network elements (NEs). FIG. 1 illustrates an example of N=10. The network device 4-k (k is any of 1 to N) may be a network switch configured to support the OFP.

The “network switch” supporting the OFP may be called an “OF switch (OF-SW)”. The “OF switch 4-k” may be abbreviated as the “OF switch 4” or “switch 4” when not requested for differentiation. The network 2 including the OF switch 4 may also be called the “OF network 2”.

The OFC 3 may perform centralized control of multiple OF switches 4 included in the OF network 2. In other words, a single OFC 3 may perform centralized control of the entire operations in the network 2.

For example, the OFC 3 may be communicably connected to the respective OF switches 4 to control communication between the OF switches 4. A transmission control protocol (TCP) and a transport layer security (TLS) may be applied to the connection between the OFC 3 and the OF switches 4. In other words, TCP and TLS “sessions” may be set and established between the OFC 3 and the OF switches 4.

The communication between the OF switches 4 is data transfer on a data plane, for example, which may be called a “data flow” or simply a “flow”. The data transferred in the “flow” may be packet data. The packet data may be simply called a “packet”.

A flow path in the OF network 2 may be called a “data path”. The “data path” may be identified on the basis of “data path identifiers” (data path IDs) assigned to the respective OF switches 4.

The OFC 3 may manage and control the flows between the OF switches 4 in an integrated fashion. For example, the OFC 3 may manage and control entries in flow tables stored in the OF switches 4 in an integrated fashion.

In order to control the flows between the OF switches 4, the OFC 3 may detect topology information of the OF network 2. The topology information is an example of information that enables identification of connection relationships between the OF switches 4 in the OF network 2. On the basis of the topology information, the OFC 3 may perform path calculation and the like for the OF network 2.

For example, the OFC 3 may realize advanced traffic engineering, such as path control (which may be called “power-saving path control”) for power saving in the entire OF network 2 on the basis of the topology information of the OF network 2.

When the “flow” is set as a unit of control by the OFC 3 and a data flow is expressed as the “flow” in any combination of networks having an existing layer structure, communication control that is not dependent on layers may be realized.

The “OF” is an example of a technique to control a network by processing a specific protocol such as the OFP. On the other hand, the “SDN” is an example of a technique to enable control in an NE that does not support the OFP, by extending the concept of the OF to existing network protocols.

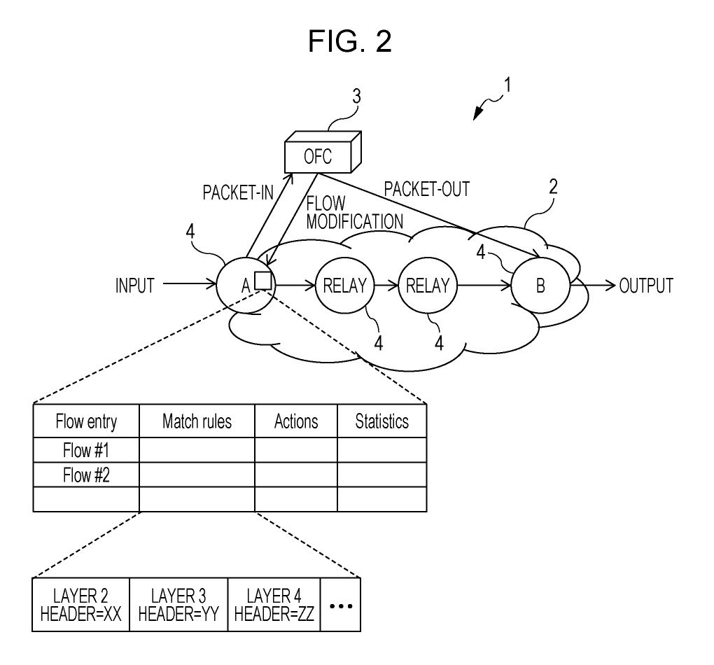

Next, an exemplary operation of the communication system 1 is described with reference to FIG. 2. Each of the OF switches 4 has a “flow table”. In the “flow table”, a “rule” and an “action” may be registered in association with each other for each “flow”.

When a packet is inputted to the OF switch 4, the OF switch 4 refers to the “flow table” and performs the “action” that matches the “rule” registered in the “flow table”.

When the “rule” corresponding to the input packet is not registered in the “flow table”, the OF switch 4 may transmit a message inquiring about the “rule” to the OFC 3. The message may be called a “packet-in message” or simply “packet-in”. The packet-in may include the input packet for which the inquiry is made. The packet-in is an example of a signal to be transmitted to the OFC 3 by the OF switch 4.

Upon receipt of the packet-in from the OF switch 4, the OFC 3 transmits a “rule” corresponding to the packet included in the received packet-in to the OF switch 4 that is the source of the packet-in. A flow modification (FlowMod) message may be used to transmit the “rule”. The flow modification message is an example of a signal to be transmitted to the OF switch 4 by the OFC 3.

Upon receipt of the flow modification message from the OFC 3, the OF switch 4 sets and registers, in the “flow table”, the “rule” set in the message. After the “rule” is registered in the “flow table”, the OFC 3 may transmit the packet received through the packet-in to the OF switch 4 through a message called a “packet-out”. The packet-out is also an example of a signal to be transmitted to the OF switch 4 by the OFC 3.

Thus, the OFC 3 determines a path corresponding to the packet-in, and sets the “rule” through a flow modification message for the OF switch 4 positioned on the determined path. For example, match rules are described in the “rule”, and an “action” is specified for the match rules. In the “action”, not only transfer of the input packet but also other operations may be specified. For example, an operation of rewriting a specific header field of the input packet may be specified in the “action”.

The centralized management and control over the operations of the OF switch 4 by the OFC 3 allows the respective OF switches 4 to be configured simply at low cost, since the OF switches 4 do not have to autonomously perform advanced processing. However, in the centralized control by the OFC 3, an increase in the number of the OF switches 4 with an increase in network size may result in an overload on the OFC 3.

Therefore, it has been considered to apply a “distributed network controller”, which is obtained by forming a “cluster” using multiple controllers and logically operates as one controller, to the OFC 3. As a non-limiting example, FIG. 1 illustrates an example where one OFC 3 is configured using a “cluster” of three controllers C1, C2, and C3.

The respective controllers included in the “cluster” may be called “element controllers” or “controller components” as appropriate. For example, a computer such as a server may correspond to the element controller. The number of the element controllers is not limited to 3 but may be 2, or 4 or more.

The OFC 3 illustrated in FIG. 1 is an example of the “distributed network controller”, and may also be called a “controller cluster 3”. The controller cluster 3 is recognized as one logical controller by the respective switches 4.

Multiple element controllers Ci (i is an integer of 2 or more) included in the controller cluster 3 may share the management (which may also be called “control”) of the OF switches 4. The communication system 1 illustrated in FIG. 1 is an example of a system for controlling the multiple switches 4 with the multiple controllers Ci in a distributed manner.

In FIG. 1, the element controller C1 may be responsible for the management of the OF switches 4-1 to 4-3, for example. The element controller C2 may be responsible for the management of the OF switches 4-4 to 4-7, for example. The element controller C3 may be responsible for the management of the OF switches 4-8 to 4-10, for example.

Note that, in FIG. 1, “SWij” represents the OF switch 4 having the switch number “j”, which is managed by the element controller Ci having the controller number “i”. “j” may be an integer of 1 or more.

For example, “SW11”, “SW12”, and “SW13” represent the OF switches 4 having the switch numbers “1” to “3” managed by the element controllers C1, respectively.

Likewise, “SW21”, “SW22”, “SW23”, and “SW24” represent the OF switches 4 having the switch numbers “1” to “4” managed by the element controllers C2, respectively.

Also, “SW31”, “SW32”, and “SW33” represent the OF switches 4 having the switch numbers “1” to “3” managed by the element controllers C3, respectively.

Note that the controller number (i) may be regarded as an example of identification information of the element controller Ci, and the switch number (j) may be regarded as an example of identification information of the OF switch 4.

By applying the “distributed network controller” configured as the “controller cluster” to the OFC 3, scalability and fault tolerance of the OFC 3 may be improved. However, there may be a case where a load is imbalanced in some of the multiple element controllers Ci included in the OFC 3.

The “load” may be determined on the basis of the number of the OF switches 4 managed by the element controller Ci, the loads on the element controllers, and the like. The load on the element controller Ci may be determined on the basis of the utilization of a processor such as a central processing unit (CPU) responsible for the operations of the element controller Ci, the utilization of a memory to be accessed by the element controller Ci due to the operations, and the like.

By performing load distribution control in the OFC 3 so as to remove or reduce load imbalance among the multiple element controllers Ci, stable operation of the OFC 3 is enabled. Examples of the load distribution control include control to change the manager of some of the OF switches 4 managed by an element controller Ci whose load is desired to be reduced, to another element controller Ci with a relatively low load.

Changing an OF switch 4 to be managed by an element controller Ci may be rephrased as changing a manager of an OF switch 4. The controller Ci managing the OF switch 4 before the manager thereof is changed may be called a “former controller Ci” as appropriate.

A controller Cx (x is an integer different from i among the integers that may be taken by i) to be a new manager of the OF switch 4 may be called a “substitute controller Cx” as appropriate. The “former controller” is an example of a “first controller”, and the “substitute controller” is an example of a “second controller”.

However, there may be a case where, even if the load distribution control as described above is performed simply on the basis of the loads on the respective controllers Ci, the loads are not successfully distributed, which hinders the convergence of the load distribution. As a non-limiting example, the following two cases are conceivable.

Case 1-1

When the processing for the OF switch 4 whose manager controller Ci is changed is not a major cause of the load on the former controller Ci, the load on the former controller Ci is not significantly reduced. Thus, the load distribution control may be requested again. For example, even if the load on the controller Ci is monitored, processing of which OF switch 4 causes the increased load on the controller Ci is not determined, resulting in the “case 1-1”.

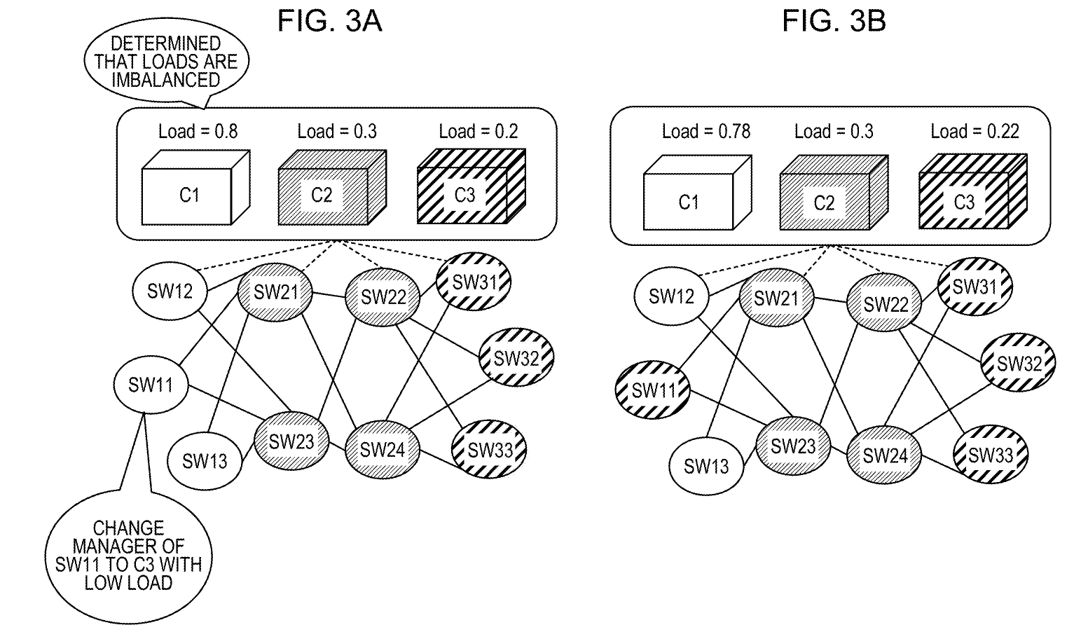

FIGS. 3A and 3B illustrate an example of the “case 1-1” where the loads are not successfully distributed. Here, it is assumed that the load on the controller Ci is calculated as a value within a range of “0.0 to 1.0” on the basis of CPU utilization and memory utilization, for example.

As illustrated in FIG. 3A, the loads on the controllers C1, C2, and C3 are “0.8, 0.3, 0.2”, respectively, and there is load imbalance. Here, by the load distribution control, the manager of any one (for example, “SW11”) of the “SW11”, “SW12”, and “SW13” that are managed by the controller C1 having the maximum load (0.8) is changed, for example, to the controller C3 having the minimum load (0.2).

If the processing load for the “SW11” is “0.02”, which is not a major cause of the load on the controller C1, the load on the former controller C1 is “0.78” and the load on the substitute controller C3 is “0.22”, as illustrated in FIG. 3B. Therefore, the load on the former controller C1 is not reduced, and the load distribution control is to be performed again.

Case 1-2

Contrary to the “case 1-1”, when the processing for the OF switch 4 whose manager controller Ci is changed is the major cause of the load on the controller Ci, the load on the substitute controller Cx may be increased too much. In this case, again, the load distribution control may be requested again.

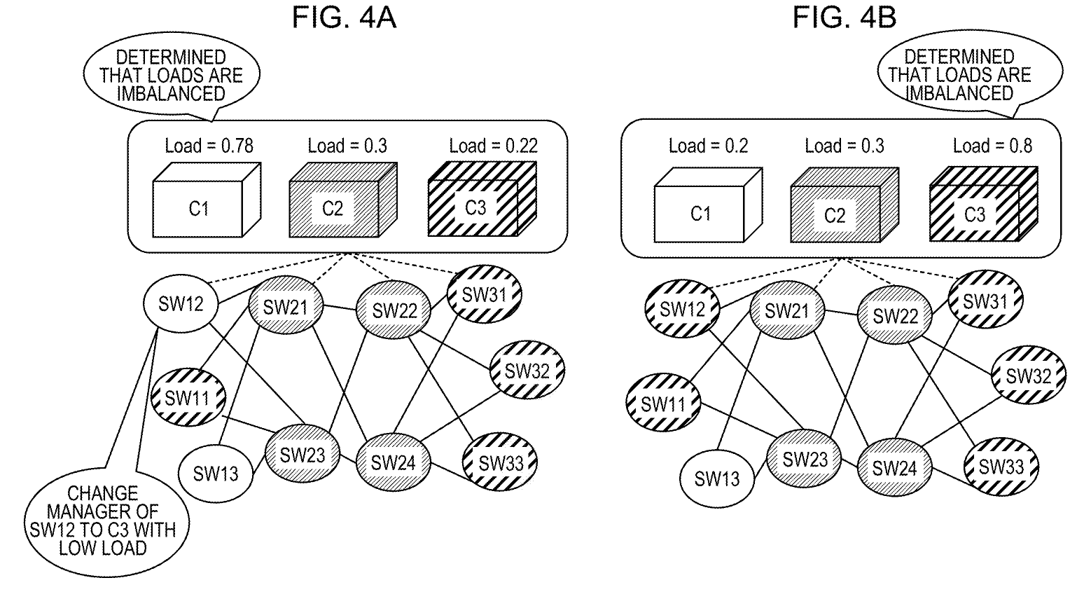

FIGS. 4A and 4B illustrate an example of the “case 1-2” where the loads are not successfully distributed. FIGS. 4A and 4B illustrate a case where another (second) load distribution control is performed when the load is not successfully distributed as in the case of the “case 1-1” illustrated in FIGS. 3A and 3B.

As illustrated in FIG. 4A, it is assumed that the loads on the controllers C1, C2, and C3 are set to “0.78, 0.3, 0.22”, respectively, by the first load distribution control in the “case 1-1”. In the second load distribution control, the manager of “SW12” that is managed by the controller C1 having the maximum load (0.78) is changed, for example, to the controller C3 having the minimum load (0.22).

Here, if the processing load for the “SW12” is “0.58”, which is the major cause of the load on the controller C1, the load on the former controller C1 is significantly reduced to “0.2” as illustrated in FIG. 4B. However, the load on the substitute controller C3 is significantly increased to “0.8”. Therefore, load imbalance is caused again among the controllers C1 to C3. As a result, the load distribution control is to be performed again.

In order to reduce or suppress the occurrence of the “case 1-1” and “case 1-2” as described above, according to the embodiment, the load imbalance among the controllers Ci is efficiently reduced to enable the load distribution control to be quickly completed. The quick completion of the load distribution control enables a stable operation of the OFC 3, and thus may realize a stable operation of the network 2.

For example, the OFC 3 according to the embodiment determines what kind of processing on which switch 4 is the cause of the load on the element controller Ci, for example. The “determination” of the cause of the load may be called “recognition” or “identification”.

In order to enable the determination of the cause of the load, the OFC 3 may store information in a storage medium, the information indicating throughput characteristics depending on the communications between each of the controllers Ci and the respective switches 4 managed by the controller Ci. Such information is stored for each of the switches 4, and may be called “attribute information”, “characteristic information” or “detailed information” on a switch 4 as appropriate.

An example of the “attribute information” is the number of signals (for example, packet-ins) to be transmitted to the OFC 3 from the respective switches 4. The number of packet-ins may be recorded in the storage medium for each of the switches 4. Another example of the “attribute information” is the number of signals (for example, flow modification messages or packet-outs) to be transmitted to the respective switches 4 by the OFC 3. The number of flow modification messages or packet-outs may be recorded in the storage medium for each of the switches 4. As the storage medium, a flash memory, a hard disk drive (HDD), a solid state drive (SSD) or the like may be applied.

The number of packet-ins may be regarded as an example of an index indicating throughput related to execution of processing corresponding to a request or inquiry from each of the switches 4 by the OFC 3. For example, due to the occurrence of new communication in a data plane, a packet-in is transmitted to the OFC 3 from the switch 4. The number of flow modification messages or packet-outs may be regarded as an example of an index indicating throughput related to control to be performed to the respective switches 4 by the OFC 3.

During a normal operation, the OFC 3 may monitor the load on each controller Ci without referring to the recorded “attribute information” of each switch 4. Thus, an increase in processing load on the OFC 3 may be avoided or suppressed, which is caused by frequent access to the “attribute information” that is the “detailed information” of the switch 4 by the OFC 3.

When detecting that there is load imbalance among the controllers Ci in the load monitoring, the OFC 3 may access the “detailed information”. For example, if the number of the switches 4 managed may be determined as the same or substantially the same among the controllers Ci having load imbalance, the OFC 3 may access and check the “detailed information”.

The OFC 3 may check whether there is a specific switch 4 that is the cause of the load on the controller Ci having a relatively high load, on the basis of the “detailed information”.

For example, there may be a switch 4 that is the destination of flow modification messages transmitted by the OFC 3 at a specific proportion (for example, 60%) or more of the total number of flow modification messages per unit time. If the presence of such a switch 4 is confirmed, the OFC 3 may identify the switch 4 as a switch 4 having “many flow modifications (FlowMods)”. The same may apply to the packet-out.

As for the packet-in, again, there may be a switch 4 that is the source of packet-ins at a specific proportion (for example, 60%) or more of the total number of packet-ins received per unit time. If the presence of such a switch 4 is confirmed, the OFC 3 may identify the switch 4 as a switch 4 having “many packet-ins”.

The “identification of the switch 4” may be rephrased as “recognition of the switch 4” or “determination of the switch 4”. The “number of flow modification messages” and the “number of packet-ins” may be collectively called the “number of messages”.

Since the number or amount of processing corresponding to the “number of messages” is performed by the controller Ci, the “number of messages” may be rephrased as the “number of processed messages” or “amount of processed messages”.

Therefore, the “number of flow modification messages” and the “number of packet-ins” may be rephrased as the “number (or amount) of processed flow modification messages” and the “number (or amount) of processed packet-ins”, respectively. The “message” is an example of a “signal”, and may be rephrased as “data”.

When the switch 4 having “many flow modifications” or “many packet-ins” is identified as described above, the OFC 3 may exclude the identified switch 4 from switch candidates for changing the manager controller Ci.

The reason for the above is because changing the manager of such a switch 4 leads to a possibility that the load on the substitute controller Cx is increased too much as in the “case 1-2” described above.

If there is no imbalance in throughput for the respective switches 4 managed by the element controller Ci, the OFC 3 does not have to perform the identification of the switch 4 described above. The OFC 3 may change the manager of any of the switches 4 managed by the controller Ci having a relatively high load, so as to reduce the number of switches managed by the controller Ci, for example.

In selecting the substitute controller Cx, the OFC 3 may check the “attribute information” of the switches 4 managed by the substitute controller Cx. For example, a switch 4 having “many packet-ins” at the present (or past) or a switch 4 having “many flow modifications” at the present (or past) may be set as the switch candidate for changing the manager.

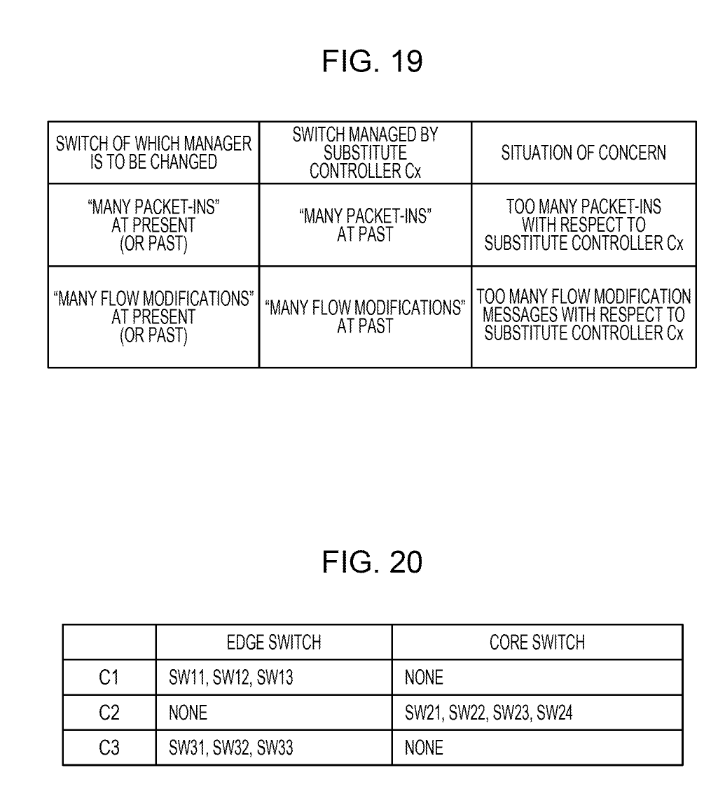

In this case, the OFC 3 may check whether there is a switch 4 having “many packet-ins” at the past or a switch 4 having “many flow modifications” at the past in the substitute controller Cx, as illustrated in FIG. 19.

For example, when a controller Cx managing a switch 4 having “many packet-ins” at the past is changed to the manager of a switch 4 having “many packet-ins” at the present (or past), the number of packet-ins to be processed by the substitute controller Cx may be increased too much.

Likewise, when a controller Cx managing a switch 4 having “many flow modifications” at the past is changed to manager of a switch 4 having “many flow modifications” at the present (or past), the number of flow modification messages to be processed by the substitute controller Cx may be increased too much.

Therefore, the OFC 3 may exclude a controller managing relatively many switches 4 having “many packet-ins” or “many flow modifications” at the past from candidates for the substitute controller Cx. Alternatively, the OFC 3 may provide controllers with priority or weighting in selection, so that such a controller is less likely to be selected as the substitute controller Cx.

In other words, the OFC 3 may control the selection of the substitute controller Cx such that a controller which has experienced a high load situation at the past is not selected or is less likely to be selected as a new manager of a switch 4 that is the cause of increased load on the controller Ci at the present or past.

For example, the OFC 3 may preferentially select, as the substitute controller Cx, a controller having a low amount of processed packet-ins or processed flow modification messages at the present or past. A controller having a relatively low load at the present may be determined as having a small number of processed packet-ins or processed flow modification messages at the present.

The selection control for the substitute controller Cx on the basis of the attribute information of the switch 4 as described above may reduce or suppress too much increase in specific message processing, for example, packet-in processing or flow modification message processing by the substitute controller Cx, after the switch manager is changed. Therefore, an overload on the substitute controller Cx may be reduced or suppressed.

For example, the following two cases are assumed.

(Case 2-1) The numbers of flow modification messages (FlowMods) processed by two switches 4 are both “10” (“20” in total), and the numbers of processed packet-ins thereby are both “200” (“400” in total).

(Case 2-2) As for one of the two switches 4, the number of processed flow modification messages is “200” and the number of processed packet-ins is “10”. As for the other switch 4, the number of processed flow modification messages is “10” and the number of processed packet-ins is “200”.

In the case 2-1, as for the controller Ci managing the two switches 4, the number of processed flow modification messages is “20” and the number of processed packet-ins is “400.”

On the other hand, in the case 2-2, the number of processed flow modification messages is “210” and the number of processed packet-ins is “210”. Since the flow modification message processing and the packet-in processing are different from each other, the case 2-2 is the situation not concentrated on specific processing, compared with the case 2-1, and it may be said that the loads on the controller Ci is distributed more in the case 2-2 than in the case 2-1, even though both cases have the same total value “420”.

Therefore, the selection control for the substitute controller Cx on the basis of the attribute information of the switch 4 as described with reference to FIG. 19 may avoid or suppress imbalanced processing load in one of the flow modification message processing and the packet-in processing.

The OFC 3 may check the position (for example, edge or core) of the switch 4 in the topology of the network 2, instead of (or in addition to) the number of processed messages, and select the switch 4 whose manager controller Ci is to be changed.

For example, the “edge” of the network 2 corresponds to an “entrance” through which new packets flow in. Therefore, the switch 4 (which may be called an “edge switch 4”) positioned at the “edge” tends to have many packet-ins to be transmitted to the OFC 3.

On the other hand, the switch 4 (which may be called a “core switch 4”) positioned at the “core” of the network 2, rather than the “edge”, tends to have more paths passing through the core switch 4 than the edge switch 4 as the core switch 4 is closer to the center of the network 2. Therefore, the core switch 4 tends to have more flow modification messages to be received from the OFC 3 for setting the paths than the edge switch 4.

Therefore, the OFC 3 may select the switch 4 whose manager controller Ci is to be changed, on the basis of the tendency of the number of messages for each message type, depending on the position of the switch 4 in the network 2.

For example, information indicating whether the switch 4 is the “edge switch” or the “core switch” may be stored in the OFC 3 for each switch 4. Such information may be called “switch type information” as appropriate. The “switch type information” may be regarded as an example of the “attribute information” of the switch 4.

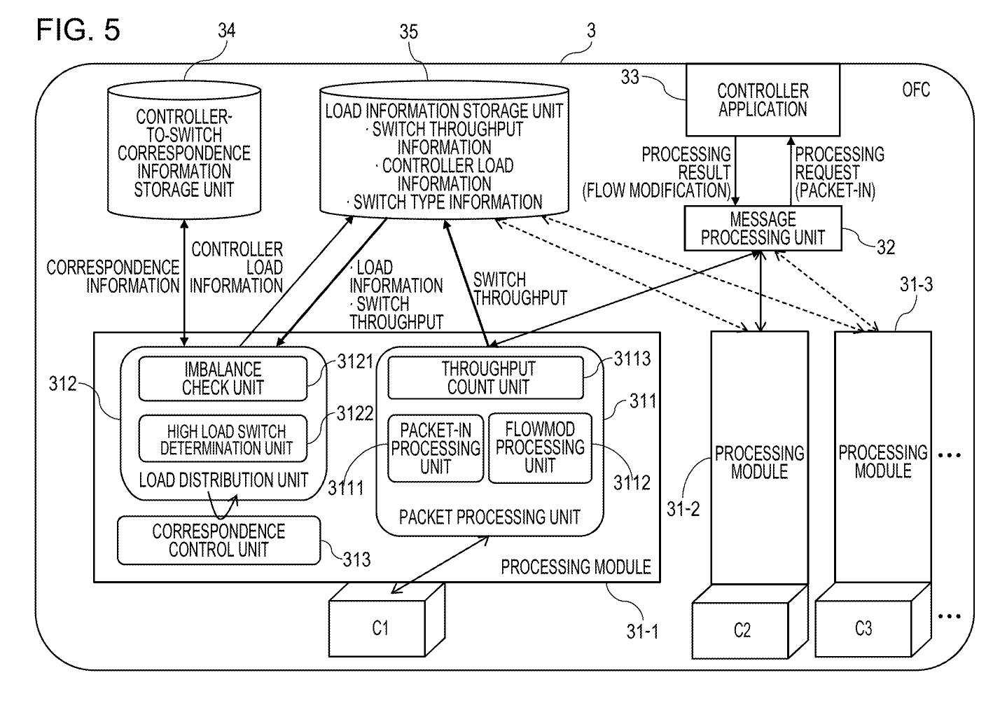

Hereinafter, with reference to FIG. 5, description is given of an exemplary configuration of the OFC 3 to realize the load distribution control among the element controllers Ci as described above. The “load distribution control among the element controllers Ci” may be the concept including the selection control for the switch 4 whose manager controller Ci is to be changed and the selection control for the substitute controller Cx, on the basis of the “attribute information” of each switch 4.

FIG. 5 is a diagram illustrating an exemplary configuration of the OFC 3. As illustrated in FIG. 5, the OFC 3 may include the element controllers Ci, processing modules 31-i corresponding to the element controllers Ci, a message processing unit 32, a controller application 33, and storage units 34 and 35. The processing modules 31-i may be simply described as the “processing modules 31” when not requested for differentiation.

Each of the processing modules 31-i is communicably connected to the corresponding element controller Ci, and performs processing for communication between the element controller Ci and any of the switches 4 managed by the element controller Ci.

Each of the processing modules 31-i may transmit and receive information to and from the message processing unit 32, and may also write and read information by accessing the storage units 34 and 35.

The processing module 31-i is an example of a selection control unit configured to control the selection (or assignment) of the switch 4 to be managed by the element controller Ci.

Some of or all of functions (“functions” may be generated as “processes” as described later) to be described later, which are realized in the processing module 31-i, may be included in the corresponding element controller Ci. For example, some of or all of the functions or processes to be described later of the processing module 31-i may be integrated in the functions or processes of the element controller Ci.

The message processing unit 32 processes messages such as packet-ins or flow modification messages, which are transmitted and received between the respective processing modules 31-i and the controller application 33.

For example, upon receipt of a packet-in from any of the processing modules 31-i, the message processing unit 32 issues a packet-in processing request to the controller application 33.

The message processing unit 32 receives setting information of a flow modification message, as an example of the processing result for the packet-in processing request, from the controller application 33. Upon receipt of the setting information, the message processing unit 32 transmits the setting information to the processing module 31-i corresponding to the manager controller Ci of the switch 4 to be set.

As for flow modification messages to the “SW12”, “SW21”, “SW22”, and “SW31”, for example, the message processing unit 32 sends the following setting information to the processing modules 31-1 to 31-3 corresponding to the controllers C1, C2, and C3, respectively.

The processing module 31-1 corresponding to C1: setting information for “SW12”

The processing module 31-2 corresponding to C2: setting information for “SW21” and “SW22”

The processing module 31-3 corresponding to C3: setting information for “SW31”

As described above, the controller application 33 performs processing corresponding to the processing request received from the message processing unit 32 and sends the processing result back to the message processing unit 32.

As illustrated in FIG. 5, each of the processing modules 31-i may include a packet processing unit 311, a load distribution unit 312, and a controller-switch correspondence control unit 313 (correspondence control unit).

The packet processing unit 311 may process messages (such as packet-ins or flow modification messages) transmitted and received by the element controller Ci, and count the amount of processed messages.

Therefore, the packet processing unit 311 may include a packet-in processing unit 3111, a flow modification message processing unit 3112 (FlowMod processing unit), and a throughput count unit 3113, for example.

Upon receipt of a packet-in from the corresponding controller Ci, for example, the packet-in processing unit 3111 transmits the contents of the received packet-in to the message processing unit 32.

The FlowMod processing unit 3112 generates a flow modification message on the basis of the information to be set in the flow modification message, which is received from the message processing unit 32, for example, and transmits the generated flow modification message to the corresponding controller Ci.

The throughput count unit 3113 is an example of a measurement unit configured to measure an amount of signals transmitted and received per unit time between a switch 4 and a controller Ci for each of the switches 4 managed by the controller Ci. The count (measurement) result obtained by the throughput count unit 3113 may be used as the “attribute information” of the switch 4.

For example, the throughput count unit 3113 may count the number of processed packet-ins by the packet-in processing unit 3111, for each switch 4. For example, the throughput count unit 3113 may count the number of processed flow modification messages by the FlowMod processing unit 3112, for each switch 4. The throughput count unit 3113 may count the number of processed packet-outs, for each switch 4.

The packet processing unit 311 may store the number of processed packet-ins and the number of processed flow modification messages for each switch 4, which are counted by the throughput count unit 3113, in the storage unit 35, for example. The number of processed packet-ins and the number of processed flow modification messages for each switch 4 are examples of “switch throughput information”. The “switch throughput information” may be obtained in each of the processing modules 31-i corresponding to the controllers Ci.

The storage unit 35 may store therein load information for each controller Ci together with the “switch throughput information”. The load information of the controller Ci may be monitored by the load distribution unit 312 and stored in the storage unit 35. Thus, the storage unit 35 may be called a “load information storage unit 35” as appropriate. Moreover, the information (switch type information) indicating whether the switch 4 is an “edge switch” or a “core switch” for each switch 4 may be stored in the storage unit 35.

The storage unit 34 may store therein information indicating correspondence (which may be rephrased as “association”) between a controller Ci and a switch 4. The “information indicating correspondence” is, for example, information indicating which controller Ci manages which switch 4, and may be called “controller-to-switch correspondence information” as appropriate. Thus, the storage unit 34 may be called a “controller-to-switch correspondence information storage unit 34” as appropriate.

The storage units 34 and 35 may be individual storage units (storage devices) as illustrated in FIG. 5, or may correspond to elements or storage regions in one storage unit (or storage device). One of or both of the storage units 34 and 35 may be included in an external device of the OFC 3.

The load distribution unit 312 in the processing module 31-i may control the correspondence between the controller Ci and the switch 4 so as to reduce the load imbalance among the controllers Ci, on the basis of the information stored in the storage units 34 and 35, for example. Thus, the load distribution unit 312 may be called a “load balancer 312”. The “correspondence control” may be performed in cooperation with the controller-switch correspondence control unit 313.

Controlling the “correspondence” may be regarded as controlling the selection of the switch 4 to be managed by each of the controllers Ci, or may be regarded as controlling the assignment (or distribution) of the switches 4 to be managed by each controller Ci.

As illustrated in FIG. 5, the load balancer 312 may include an imbalance check unit 3121 and a high load switch determination unit 3122.

The imbalance check unit 3121 checks whether the numbers of the switches 4 managed are out of balance (in other words, imbalanced) among the controllers Ci, on the basis of the “controller-to-switch correspondence information” stored in the storage unit 34, for example.

The high load switch determination unit 3122 determines and identifies a switch 4 (which may be called a “high load switch 4” as appropriate) with throughput of a certain threshold or more, as described above, on the basis of the “switch throughput information” stored in the storage unit 35, for example.

The controller-switch correspondence control unit 313 (correspondence control unit) controls the correspondence between the controller Ci and the switch 4 in cooperation with the load balancer 312.

For example, the correspondence control unit 313 determines which controller Ci is set as the manager of which switch 4, in cooperation with the load balancer 312, and updates the “controller-to-switch correspondence information” stored in the storage unit 34 in accordance with the determination.

The correspondence control unit 313 may be called a “coordinator 313” or “coordinate system 313”. The coordinator 313 may be included in the load balancer 312 as one of the functions of the load balancer 312.

Each of the processing modules 31-i manages and controls the switch 4 corresponding to the controller Ci, in accordance with the “controller-to-switch correspondence information” stored in the storage unit 34. Therefore, changing the “controller-to-switch correspondence information” by update results in changing the manager controller Ci of the switch 4.

In other words, the correspondence control unit 313 (or the load balancer 312 and the correspondence control unit 313) is an example of a change unit configured to change the switch 4 to be managed by the controller Ci, on the basis of the “attribute information” of the switch 4.

The “load distribution control among the controllers Ci” may be the setting performed by one of the processing modules 31-i (which may be called a “leader module”) selected as a leader from among the processing modules 31-i.

When the multiple processing modules 31-i are set to perform the load distribution control in parallel, communication between the processing modules 31-i, adjustment control, and the like occur, and the load distribution control may be complicated. The leader module 31-i may be randomly selected.

The processing module 31-i and the message processing unit 32 described above may be “processes” generated by a processor with arithmetic ability, for example, a CPU. The processor operates by reading programs and data stored in a storage medium. The “processor” with the arithmetic ability may be called a “processor circuit” or “processor device” or may be called a “computer”.

Therefore, the processing module 31-i and the message processing unit 32 may be called a “processing module process 31-i” and a “message processing process 32”, respectively, as appropriate. The execution of the “process” may be regarded as realization of the function of the OFC 3 capable of performing the load distribution control described above.

The program for generating the “process” to realize the load distribution control described above in the OFC 3 may be called a “load distribution control program” as appropriate. The “program” may be called an “application” or “software”.

By increasing or reducing the number of “processes” by modifying the “load distribution control program”, the number of the processing modules 31-i may be easily increased or reduced, for example. Thus, a flexible response to load change in the processing performed by the OFC 3 is made possible.

The “load distribution control program” may be provided in the form of being stored in a storage medium or may be provided (in other words, “downloaded”) through a wired or wireless communication line. The “load distribution control program” stored in a storage medium such as a flash memory, for example, may be installed into the storage unit 34 or 35. Alternatively, the “load distribution control program” downloaded from a server may be installed into the storage unit 34 or 35.

A processor to execute the load distribution control program may be a processor different from a processor such as a CPU included in the element controller Ci, or may be shared as a processor included in any of the element controllers Ci.

The processing module 31-i and the message processing unit 32 may be realized using individual pieces of hardware. The processing module 31-i and the message processing unit 32 may be realized by executing independent pieces of software.

The software to realize the processing module 31-i and the software to realize the message processing unit 32 may be installed into the same computer such as a server, or may be installed into different computers and operated in the respective computers.

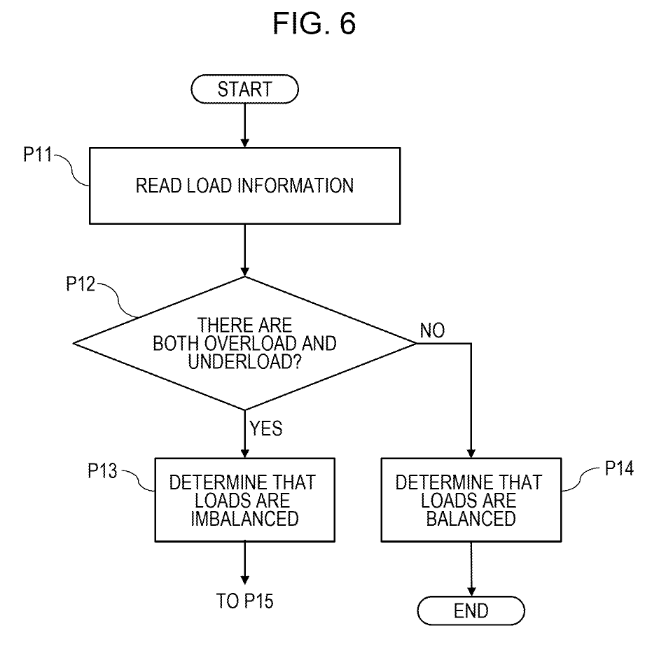

Hereinafter, with reference to FIGS. 6 to 16, description is given of processing focused on the “load distribution control among the element controllers Ci” as an exemplary operation of the OFC 3 according to the embodiment.

As illustrated in FIG. 6, the processing module 31-i selected as the leader (which may be simply called the “leader module 31”) uses the load balancer 312 to read load information for each controller Ci from the load information storage unit 35 (P11).

The load information for each controller Ci may be calculated by each of the processing modules 31-i corresponding to the respective controllers Ci, and the calculation result may be stored in the load information storage unit 35.

The load information may be calculated on the basis of information such as the CPU utilization and memory utilization of the controller Ci, the number of switches managed by the controller Ci, and the like. For example, it is assumed that the CPU utilization is X [%] and the memory utilization of the controller Ci is Y [%].

Moreover, assuming that the number of switches managed by a certain controller Ci is n (n is an integer of 1 or more) and the total number of switches managed by the OFC 3 as a whole is m (m is an integer of 2 or more), a management ratio R is R=n/m. The management ratio R is a ratio of the number n of switches managed by the controller Ci to the total number m of the switches.

In this case, load information L may be calculated by the following equation (1).

L=(Wa×X+Wb×Y)/100+Wc×R (1)

Where “Wa”, “Wb”, and “Wc” represent weight coefficients for “X”, “Y”, and “R”, respectively, and are constants that satisfy Wa+Wb+Wc=1.

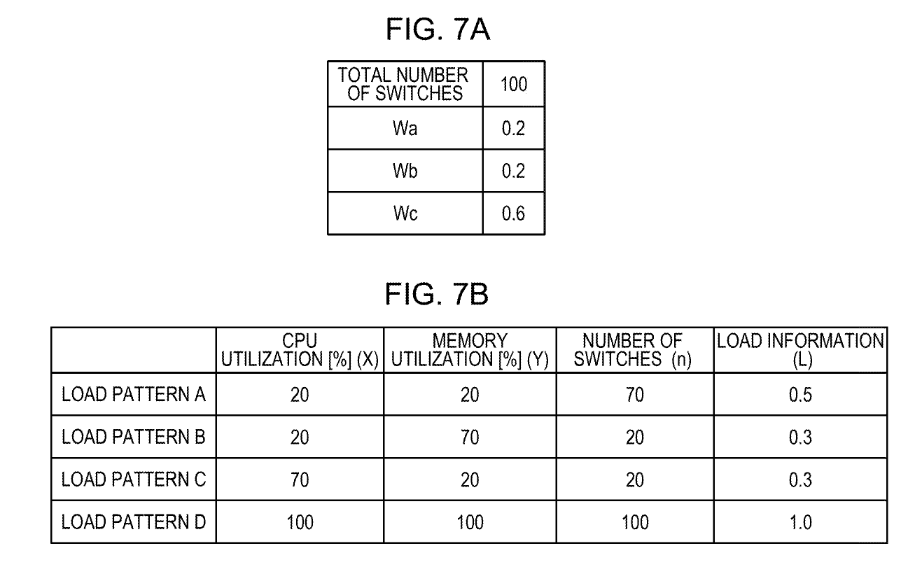

As a non-limiting example, it is assumed that, as illustrated in FIG. 7A, [Wa, Wb, Wc]=[0.2, 0.2, 0.6] and the total number m of switches has a value m=100. In this case, as illustrated as a “load pattern A” in FIG. 7B, when X=20 [%], Y=20 [%], and n=70 [units], L=(0.2×20+0.2×20)/100+0.6×70/100=0.5.

As illustrated as a “load pattern B” in FIG. 7B, when X=20 [%], Y=70 [%], and n=20 [units], L=(0.2×20+0.2×70)/100+0.6×20/100=0.3.

As illustrated as a “load pattern C” in FIG. 7B, when X=70 [%], Y=20 [%], and n=20 [units], L=(0.2×70+0.2×20)/100+0.6×20/100=0.3.

As illustrated as a “load pattern D” in FIG. 7B, the load information “L” has a value L=1 when X=100 [%], Y=100 [%], and n=100 [units].

The weight coefficients of the CPU utilization (X), memory utilization (Y), and management ratio (R) used in the calculation of the load information L may be determined depending on the CPU performance and the installed memory size of the controller Ci.

The load information L may be calculated by weighting of any two of the three parameters of the CPU utilization (X), the memory utilization (Y), and the management ratio (R), or may be calculated using any one of the parameters.

Referring back to FIG. 6, for example, the high load switch determination unit 3122 of the load balancer 312 determines whether or not there are both load information (overload) larger than an upper threshold and load information (underload) smaller than a lower threshold in the load information L (Ci) for each controller Ci (P12). Alternatively, the load balancer 312 may determine whether or not a difference between the maximum load and the minimum load among the loads of the controllers Ci exceeds a threshold (difference between the upper threshold and the lower threshold).

It is assumed that the current load information L (Ci) of the respective controllers C1, C2, and C3 have values [L (C1), L (C2), L (C3)]=[0.8, 0.3, 0.2], the upper threshold TH1=0.7, and the lower threshold TH2=0.3.

In this example, there is the controller C1 having the load information L (C1)=0.8 exceeding the upper threshold TH1=0.7, and there is the controller C3 having the load information L (C3)=0.2 below the lower threshold TH2=0.3.

Therefore, the load balancer 312 determines that the load information is imbalanced among the controllers C1 to C3 (YES in P12 and P13). Such imbalance determination may be performed by the high load switch determination unit 3122, for example.

When there is no load information larger than the upper threshold TH1 or no load information smaller than the lower threshold TH2 in P12, the load balancer 312 may terminate the processing after determining that the load information is balanced (NO in P12 and P14).

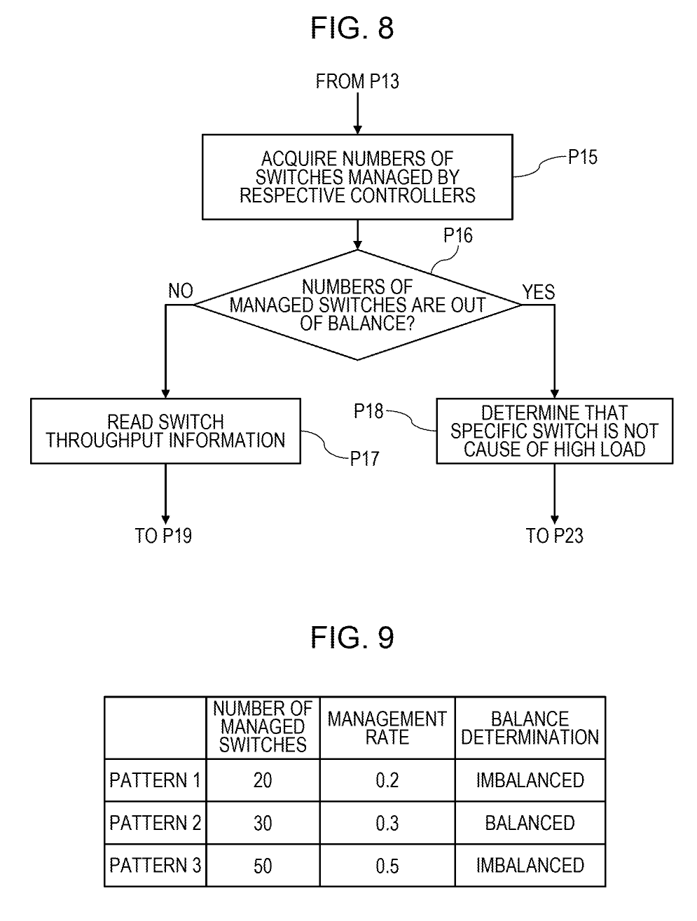

In response to the determination that “the load information is imbalanced”, the imbalance check unit 3121 of the load balancer 312, for example, reads the controller-to-switch correspondence information for each controller Ci from the storage unit 34, as illustrated in FIG. 8 (P15).

The imbalance check unit 3121 checks whether the numbers (which may be called “numbers of managed switches” as appropriate) of the switches managed by the respective controllers Ci are out of balance, on the basis of the read controller-to-switch correspondence information for each controller Ci (P16).

For example, the imbalance check unit 3121 calculates the management ratio R=n/m and obtains the average Rav=1/Q of the management ratios assuming that the number (in other words, the maximum value of the number that may be taken by “i”) of the controllers Ci is Q.

Then, the imbalance check unit 3121 determines that there is no imbalance when the management ratio R is within the range that satisfies (Rav)×0.8<R<(Rav)>1.2, and determines that there is imbalance when the management ratio R is outside the range, as a non-limiting example.

For example, assuming that the number Q of the controllers Ci has a value Q=3, then the average Rav of the management ratios is 1/3. Thus, the range of the management ratio R to determine that “there is no imbalance” is 0.27<R<0.4. In other words, the imbalance check unit 3121 determines whether or not a difference in the number of managed switches among the controllers Ci is within a predetermined range.

Here, assuming that the total number m of switches has a value m=100 and the three controllers C1, C2, and C3 manage 20, 30, and 50 switches 4, respectively, the management ratios R (C1), R (C2), and R (C3) of the controllers C1, C2, and C3 are as follows, respectively.

R(C1)=20/100=0.2

R(C2)=30/100=0.3

R(C3)=50/100=0.5

Therefore, the imbalance check unit 3121 may determine that the numbers of the switches managed by the controllers C1, C2, and C3 are “imbalanced”, “balanced”, and “imbalanced”, respectively, as illustrated in FIG. 9.

When it is determined that there is no imbalance in the number of managed switches among the controllers Ci even though the load information is imbalanced among the controllers Ci (NO in P16), the load balancer 312 reads the switch throughput information from the storage unit 35 (P17). P17 may be regarded as corresponding to reading of the “detailed information” described above.

The switch throughput information may be read by the high load switch determination unit 3122, for example. The read switch throughput information includes information indicating the number of processed packet-ins and the number of processed flow modification messages for each switch 4, which are counted by the throughput count unit 3113, for example.

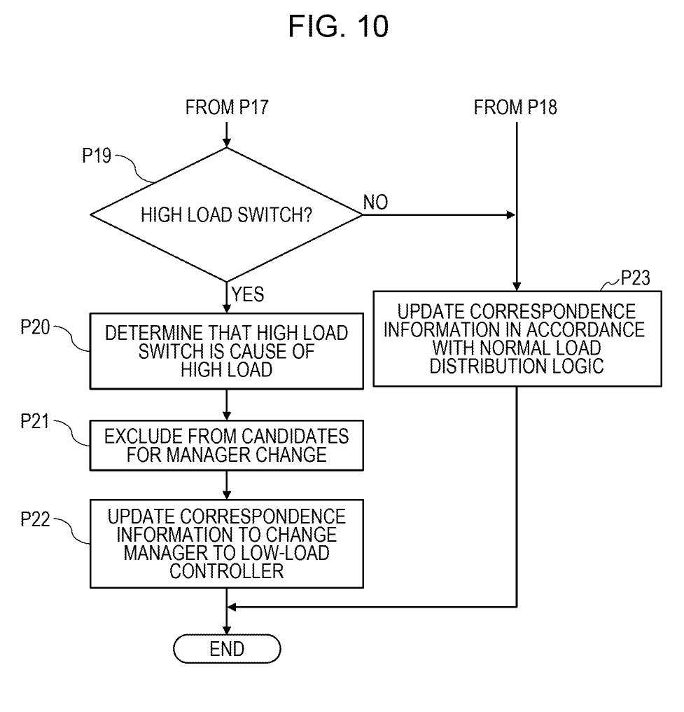

As illustrated in FIG. 10, the high load switch determination unit 3122 determines whether or not there is a specific high load switch 4 among the switches 4 managed by the controller Ci determined as “imbalanced”, on the basis of the read switch throughput information (P19).

The determination of whether or not there is a high load switch 4 may be performed by determining whether or not there are relatively many processed packet-ins or relatively many processed flow modification messages in the switch throughput information, for example.

For example, the numbers of packet-ins and flow modification messages to be processed in total per unit time by the processing module 31-i corresponding to the controller Ci determined as “imbalanced” are expressed as “Pin (tot)” and “Fmod (tot)”, respectively.

Furthermore, the numbers of packet-ins and flow modification messages to be processed per unit time by the respective switches 4 managed by the controller Ci determined as “imbalanced” are expressed as “Pin (SWk)” and “Fmod (SWk)”, respectively. Where “k” in “SWk” represents the switch number.

The high load switch determination unit 3122 may determine that the switch 4 having the switch number k that satisfies the following equation (2) is a high load switch 4, assuming that a determination threshold is “0.6”.

[Pin(SWk)+Fmod(SWk)]/[Pin(tot)+Fmod(tot)]>0.6 (2)

In other words, the high load switch determination unit 3122 may determine that a switch 4 processing packet-ins and flow modification messages exceeding 60 [%] of the total in the respective processing modules 31-i is the high load switch 4 (P20).

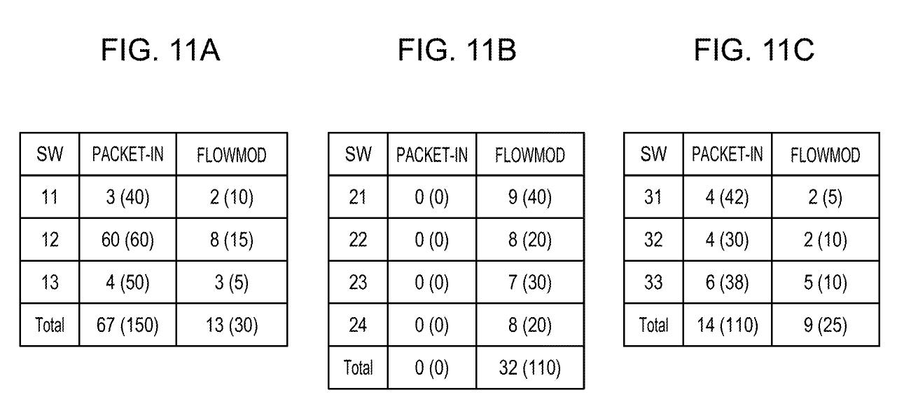

As a non-limiting example, FIGS. 11A to 11C illustrate an example of the switch throughput information for the controllers C1 to C3, respectively. In FIGS. 11A to 11C, “packet-in” represents the number of processed packet-ins inputted to the processing module 31-i from the switch 4, and “FlowMod” represents the number of flow modification messages outputted to the switch 4 from the processing module 31-i. The values in parentheses represent the past maximum values of the number of processed packet-ins and processed flow modification messages.

In this example, the numbers of switches managed by the controllers C1 to C3 are approximately the same (3 or 4). Thus, the imbalance check unit 3121 determines that the numbers of managed switches are balanced (NO in P16).

In response to the determination described above, the high load switch determination unit 3122 recognizes, referring to the switch throughput information, that the amount of packet-ins for the controller C1 is as many as “67” and the amount of processed packet-ins for “SW12” is 90%.

Therefore, the high load switch determination unit 3122 determines “SW12” exceeding 60% of the total amount of processed packet-ins for the controller C1 as the “high load switch 4” having “many packet-ins”.

Since the high load switch “SW12” has “many packet-ins”, when the manager of the high load switch “SW12” is changed to another controller C2 or C3, the load on the substitute controller C2 or C3 may be increased too much. Therefore, the high load switch determination unit 3122 may exclude the high load switch “SW12” from switch candidates which are allowed to change the manager thereof (P21).

The load balancer 312 changes the manager of “SW11” and “SW13” managed by the controller C1, except for “SW12”, to the other controller C2 or C3 with a load lower than that of the controller C1, in cooperation with the correspondence control unit 313 (P22).

Here, the controller C3 having the lowest load information “0.2”, between the controllers C2 and C3, may be determined as the substitute manager. However, the load balancer 312 may determine the substitute controller Cx by referring to the past maximum values in the switch throughput information.

For example, the correspondence control unit 313 of the load balancer 312 refers to the past maximum values indicated by the values in parentheses in the switch throughput information of the controller C1 illustrated in FIG. 11A.

The past maximum values of the amount (Pin) of processed packet-ins for the switch candidates “SW11” and “SW13” for changing the manager are “40” and “50”, respectively, which in total account for 60% of the total maximum value “150”. Therefore, the correspondence control unit 313 may determine “SW11” and “SW13” as the switches 4 having “many packet-ins” at the past.

On the other hand, the past maximum values of the amount (Fmod) of processed flow modification messages for “SW11” and “SW13” are “10” and “5”, respectively, which in total account for 50% of the total maximum value “30”. Therefore, since the maximum values are less than 60%, the correspondence control unit 313 may determine “SW11” and “SW13” as the switches 4 having “less flow modifications” at the past.

The correspondence control unit 313 may similarly check the past maximum values for the switches 4 managed by the controllers C2 and C3, on the basis of the switch throughput information of the controllers C2 and C3 illustrated in FIGS. 11B and 11C.

For example, FIG. 11B illustrates that, as for the controller C2, the past maximum value of the total amount of processed packet-ins is “0”, while the past maximum value of the total amount of processed flow modification messages is “110”.

FIG. 11C illustrates that, as for the controller C3, the past maximum value of the total amount of processed packet-ins is “110”, while the past maximum value of the total amount of processed flow modification messages is “25”.

Here, when the manager of “SW11” and “SW13” is changed to the controller C3 having the lowest load at the present, the sum of the past maximum values of the amount of processed packet-ins is “40+50+110”=“200”.

Assuming that the upper limit allowed as the past maximum value of the total amount of processed messages for each controller Ci is “200”, the packet-in processing for the controller C3 may fail. Therefore, the correspondence control unit 313 may exclude the controller C3 from new manager controller candidates for “SW11” and “SW13”.

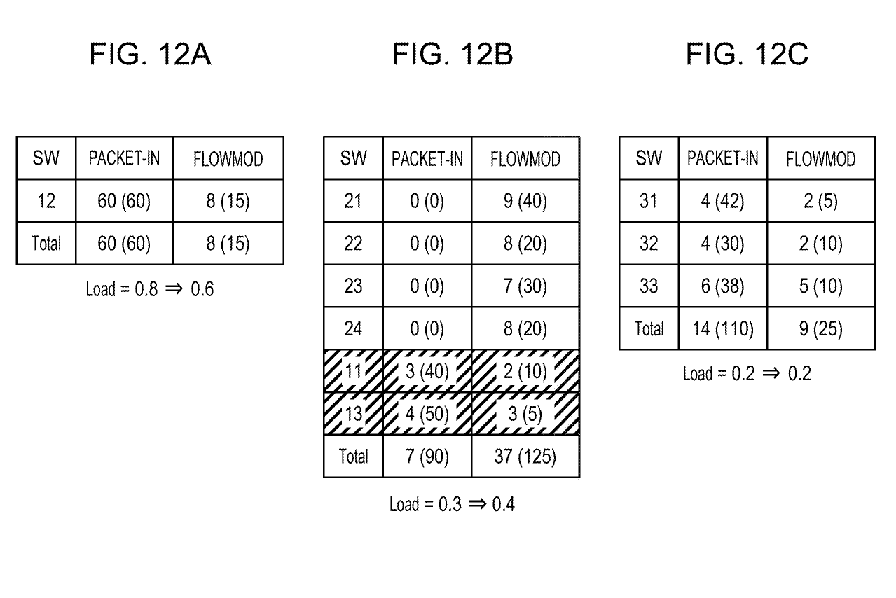

On the other hand, when the manager of “SW11” and “SW13” is changed to the controller C2 having the second lowest load at the present, the sum of the past maximum values of the amount of processed packet-ins is “40+50+0”=“90”, as illustrated in FIG. 12B. Moreover, as illustrated in FIG. 12B, the sum of the past maximum values of the amount of processed flow modification messages is “10+5+110”=“125”

The correspondence control unit 313 may determine the controller C2 as the new manager of “SW11” and “SW13” by determining that the past maximum values “90” and “125” both have a sufficient margin for the upper limit (assumed to be “200”).

In response to the determination described above, the correspondence control unit 313 updates the controller-to-switch correspondence information in the storage unit 34 such that “SW11” and “SW13” correspond to the controller C2, except for “SW12” determined as the high load switch (P22).

Thus, the manager of “SW11” and “SW13” other than “SW12” excluded from the switch candidates for changing the manager, among the switches 4 managed by the controller C1, is changed to the controller C2 having a relatively small total amount of messages of the same type at the past. The switch 4 whose manager is changed to the controller C2 may be either one of “SW11” and “SW13”.

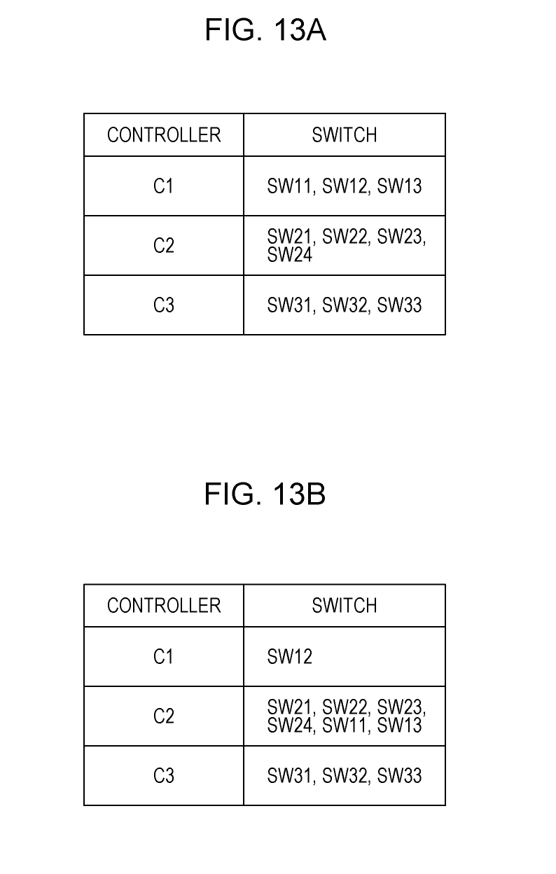

FIGS. 13A and 13B illustrate an example of updating the controller-to-switch correspondence information. FIG. 13A illustrates an example of the controller-to-switch correspondence information before the update, which is an example of correspondence information in the management state illustrated in FIG. 1.

FIG. 13B illustrates an example of the controller-to-switch correspondence information after the update. In the example of FIG. 13B, two switches “SW11” and “SW13” other than the high load switch “SW12” have been changed to correspond to the controller C2.

Thus, the manager of the high load switch “SW12” is not changed from the controller C1, and the manager of the other switches “SW11” and “SW13” is changed from the controller C1 to the controller C2.

FIGS. 12A to 12C illustrate an example of the switch throughput information of the controllers C1 to C3 after the manager is changed. As illustrated in FIG. 12A, the load information of the controller C1 is reduced from “0.8” to “0.6”, for example, since “SW11” and “SW13” are excluded from the management.

On the other hand, as illustrated in FIG. 12B, the load information of the controller C2 is increased from “0.3” to “0.4”, for example, since “SW11” and “SW13” are newly added to the management. Since there is no change in the switches 4 to be managed by the controller C3, the load information of the controller C3 is not changed from “0.2” as illustrated in FIG. 12C.

The load information is not completely equal among the controllers C1 to C3. However, since there is no longer a controller Ci exceeding the upper threshold TH1=0.7, it is not determined again in P12 of FIG. 6 that “there is imbalance” (YES).

When it is determined in P16 of FIG. 8 that the numbers of managed switches are out of balance (YES), the load balancer 312 may determine that a specific switch 4 as described above is not the cause of the controller Ci with a relatively high load (P18).

In this case, the load balancer 312 may control the correspondence between the controller Ci and the switch 4 by updating the controller-to-switch correspondence information in accordance with a normal load distribution logic, in cooperation with the correspondence control unit 313, as illustrated in FIG. 10, for example (P23).

The “normal load distribution logic” may be a logic to control the correspondence between the controller Ci and the switch 4 so as to have the load information balanced among the controllers Ci, without referring to the switch throughput information, for example.

In the “normal load distribution logic”, the load information may be calculated on the basis of the parameters such as the CPU utilization (X), the memory utilization (Y), and the management ratio (R), instead of not referring to the switch throughput information.

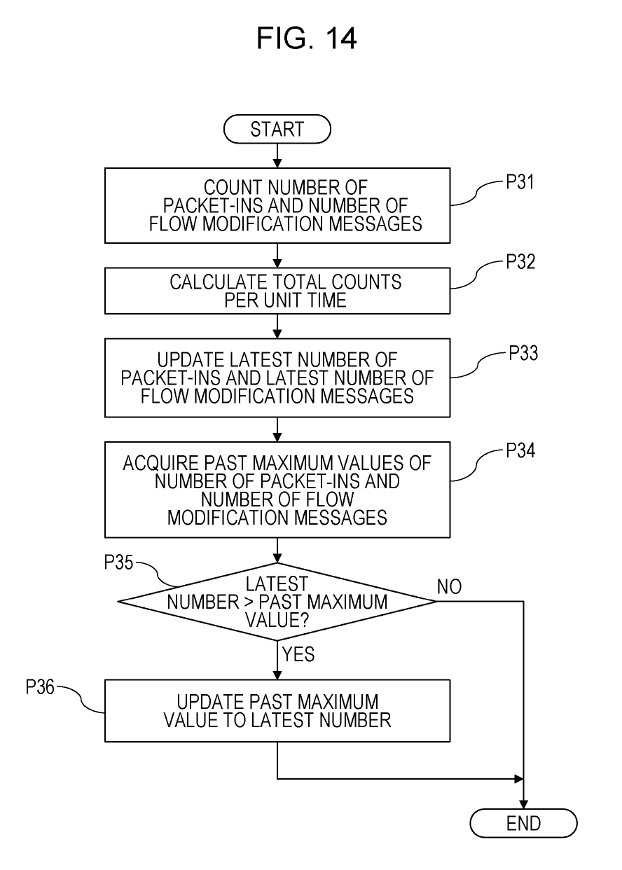

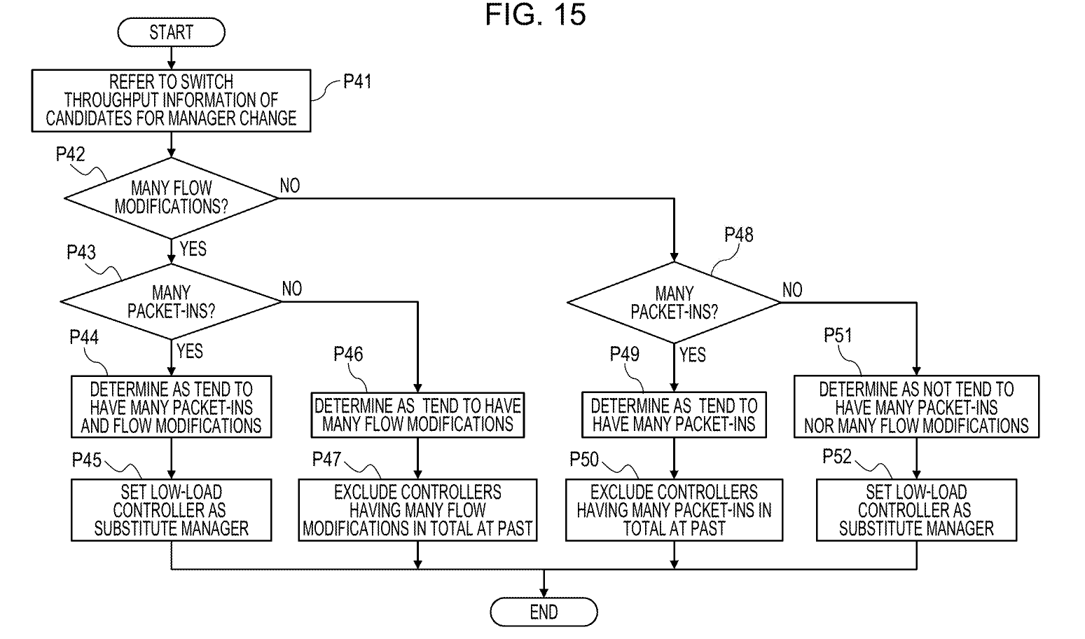

Next, with reference to FIG. 14, description is given of an exemplary operation of updating information about the past throughput for each switch 4. This exemplary operation may be regarded as corresponding to an example of an operation to update the “past maximum values” of the amount of processed packet-ins and the amount of processed flow modification messages described above.

The flowchart illustrated in FIG. 14 may be performed by the throughput count unit 3113 in the packet processing unit 311 illustrated in FIG. 5, for example. The throughput count unit 3113 counts the number of processed packet-ins in the packet-in processing unit 3111 and the number of processed flow modification messages in the FlowMod processing unit 3112 (P31).

The throughput count unit 3113 calculates total counts per unit time for each of the number of processed packet-ins and the number of processed flow modification messages (P32). The throughput count unit 3113 stores the total counts in the load information storage unit 35, for example. In this event, the current number of processed packet-ins and the current number of processed flow modification messages in the switch throughput information are updated by the calculated total counts (P33).

The throughput count unit 3113 reads the respective past maximum values of the number of processed packet-ins and the number of processed flow modification messages in the switch throughput information, from the load information storage unit 35 (P34).

The throughput count unit 3113 compares the current total counts obtained for the number of processed packet-ins and the number of processed flow modification messages in P32 with the read past maximum values (P35).

As a result of the comparison, when the current total counts are larger than the past maximum values (YES in P35), the throughput count unit 3113 updates the corresponding maximum values in the switch throughput information stored in the load information storage unit 35 with the current total counts (P36).

On the other hand, when the current total counts are not more than the past maximum values (NO in P35), the throughput count unit 3113 may terminate the update processing without updating the past maximum values.

Thus, the processing modules 31-i may update and maintain the number of processed messages stored in the load information storage unit 35 to the latest information.

Next, with reference to FIG. 15, description is given of an exemplary operation of selecting a substitute controller on the basis of the past maximum values. P41 to P52 illustrated in the flowchart of FIG. 15 may be regarded as corresponding to a detailed example of P21 illustrated in FIG. 10.

As illustrated in FIG. 15, the load balancer 312 refers to the switch throughput information for a switch 4 managed by the high load controller Ci, except for the high load switch 4 determined in P20 of FIG. 10 (P41).

Then, the load balancer 312 determines whether or not the switch 4 has “many flow modifications” at the past in the switch throughput information referred to (P42). The switch 4 corresponds to the switch 4 as the candidate for changing the manager controller Ci, and may be called a “candidate switch 4” as appropriate.

As a result of the determination, if the candidate switch 4 has “many flow modifications” at the past (YES in P42), the load balancer 312 may further determine whether or not the candidate switch 4 has “many packet-ins” at the past (P43).

If the candidate switch 4 has “many packet-ins” at the past (YES in P43), the load balancer 312 may determine that the candidate switch 4 tends to have many processed flow modification messages and many processed packet-ins (P44).

In response to the determination described above, the load balancer 312 may determine any of the candidate controllers Ci with low load as the manager of the candidate switch 4 (P45).

If the candidate switch 4 does not have “many packet-ins” at the past (NO in P43), the load balancer 312 may determine that the candidate switch 4 tends to have many processed flow modification messages (P46).

In response to the determination described above, the load balancer 312 may exclude controllers Ci having many processed flow modification messages in total at the past, among the candidate controllers Ci with low load, from new manager controller candidates for the candidate switch 4 (P47).

Thus, the manager of the candidate switch 4 tending to have many processed flow modification messages may be suppressed from being changed to a controller Ci having many processed flow modification messages in total at the past.

If the candidate switch 4 does not have “many flow modifications” at the past in P42 (NO), the load balancer 312 may further determine whether or not the candidate switch 4 has “many packet-ins” at the past (P48).

As a result of the determination, if the candidate switch 4 has “many packet-ins” at the past (YES in P48), the load balancer 312 may determine that the candidate switch 4 tends to have many processed packet-ins (P49).

In response to the determination described above, the load balancer 312 may exclude controllers Ci having many processed packet-ins in total at the past, among the candidate controllers Ci with low load, from new manager controller candidates for the candidate switch 4 (P50).

Thus, the manager of the candidate switch 4 tending to have many processed packet-ins may be suppressed from being changed to a controller Ci having many processed packet-ins in total at the past.

If the candidate switch 4 does not have “many packet-ins” at the past in P48 (NO), the load balancer 312 may determine that the candidate switch 4 does not tend to have many flow modification messages or packet-ins (P51).

In response to the determination described above, the load balancer 312 may determine any of the candidate controllers Ci with low load as the manager of the candidate switch 4 (P52).

Thus, the load balancer 312 may properly select the substitute controller Cx on the basis of the past maximum values of the number of processed messages.

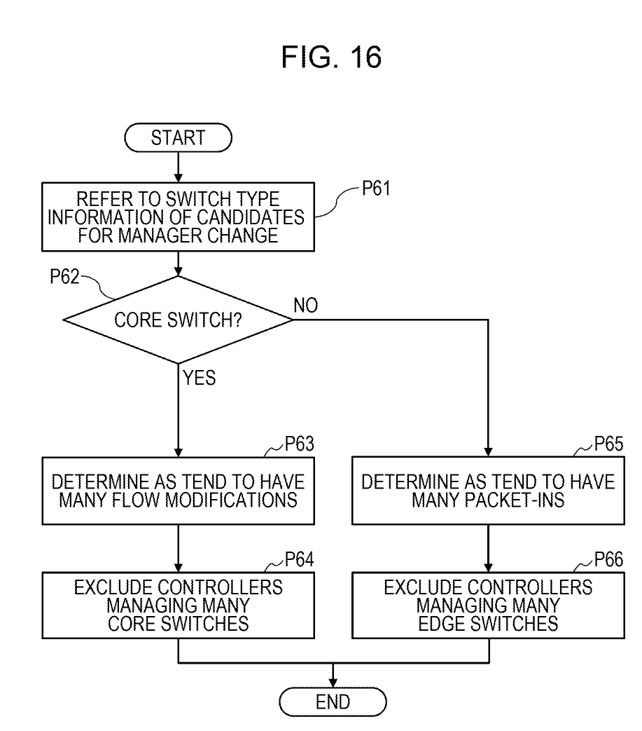

Next, with reference to FIG. 16, description is given of an example where the selection of the substitute controller Cx is controlled according to whether the candidate switch 4 corresponds to an “edge switch” or a “core switch”. P61 to P66 illustrated in FIG. 16 may be regarded as corresponding to another detailed example of P21 illustrated in FIG. 10.

As illustrated in FIG. 16, the load balancer 312 refers to the switch type information stored in the storage unit 35 for a candidate switch 4 managed by the high load controller Ci, except for the high load switch 4 determined in P20 of FIG. 10 (P61).

Then, the load balancer 312 checks whether the switch type information referred to indicates the “core switch” or the “edge switch” (P62). If the switch type information indicates the “core switch” as a result of the checking (YES in P62), the load balancer 312 may determine that the candidate switch 4 tends to have many processed flow modification messages (P63).

In response to the determination described above, the load balancer 312 may exclude controllers Ci managing a relatively large number of “core switches”, among the candidate controllers Ci with low load, from new manager controller candidates for the candidate switch 4 that is the “core switch” (P64).

Thus, the manager of the candidate core switch 4 tending to have many processed flow modification messages may be suppressed from being changed to a controller Ci managing a relatively large number of “core switches”.

If the switch type information referred to indicates the “edge switch” in P62 (NO), the load balancer 312 may determine that the candidate switch 4 tends to have many processed packet-ins (P65).

In response to the determination described above, the load balancer 312 may exclude the controller Ci managing a relatively large number of “edge switches”, among the candidate controllers Ci with low load, from new manager controller candidates for the candidate switch 4 that is the “edge switch” (P66).

Thus, the manager of the candidate edge switch 4 tending to have many processed packet-ins may be suppressed from being changed to a controller Ci managing a relatively large number of “edge switches”.

Through P61 to P66 described above, the load balancer 312 may change the correspondences between the controllers Ci and the switches 4 such that the numbers of the managed “edge switches” and “core switches” are as balanced as possible among the controllers Ci, for example.

For example, it is assumed that the type (edge or core) of the respective switches 4 managed by the controllers C1 to C3 are as illustrated in FIG. 20.

In the example of FIG. 20, the controllers C1 and C3 manage three edge switches 4, respectively, and the controller C2 manages no edge switch 4. Therefore, when any of the six edge switches 4 is selected as the switch candidate for manager change, the load balancer 312 may operate such that the controller C2 is selected as a new manager if possible.

In the example of FIG. 20, the controllers C1 and C3 manage no core switch 4, respectively, and the controller C2 manages four core switches 4. Therefore, when any of the four core switches 4 is selected as the switch candidate for manager change, the load balancer 312 may operate such that the controller C1 or C3 is selected as a new manager if possible.

Thus, the load balancer 312 may control the correspondence between the controller Ci and the switch 4 so as to balance the numbers of the edge switches 4 and core switches 4 managed among the controllers Ci.

As described above, according to the above-described embodiment, the occurrence of the “case 1-1” or “case 1-2” described above may be reduced or suppressed, where the load distribution is not successfully performed by the load distribution control based on load monitoring by the controller Ci.

For example, the difficulty in removing the load imbalance among the controllers Ci due to the load going back and forth between the controllers Ci or in reducing the load on a specific controller Ci may be reduced or suppressed.

Therefore, the number of controls and time until the load distribution is completed may be reduced. For example, in the load distribution control based on the simple load monitoring by the controller Ci, there is a possibility that about five to ten controls have to be tried before the completion. On the other hand, according to the embodiment described above, the number of controls until the completion of the load distribution control is expected to be suppressed to about one or two. Thus, stable operation of the OFC 3 is made possible, and stable operation of the network 2 may be realized.

The OFC 3 illustrated in FIG. 5 includes the individual processing modules 31-i for the respective controllers Ci (or in the controllers Ci). However, the processing module 31-i may be shared by the respective element controllers Ci.

For example, a processing module (which may be called a “shared processing module” as appropriate) shared by the respective element controllers Ci may perform the load distribution control among the controllers Ci described above in a centralized manner.

For example, the “shared processing module” may be notified of the amount of processed messages, such as packet-ins and flow modification messages, from the respective controllers Ci, and perform the load distribution control among the controllers Ci described above. The “shared processing module” may be regarded as corresponding to the “control apparatus for the controllers Ci”.

In other words, the selected processing module 31-i (or the controller Ci) or the control apparatus shared by the respective controllers Ci may perform judgment or determination of which controller Ci manages which switch 4, on the basis of the “attribute information” of the switch 4.

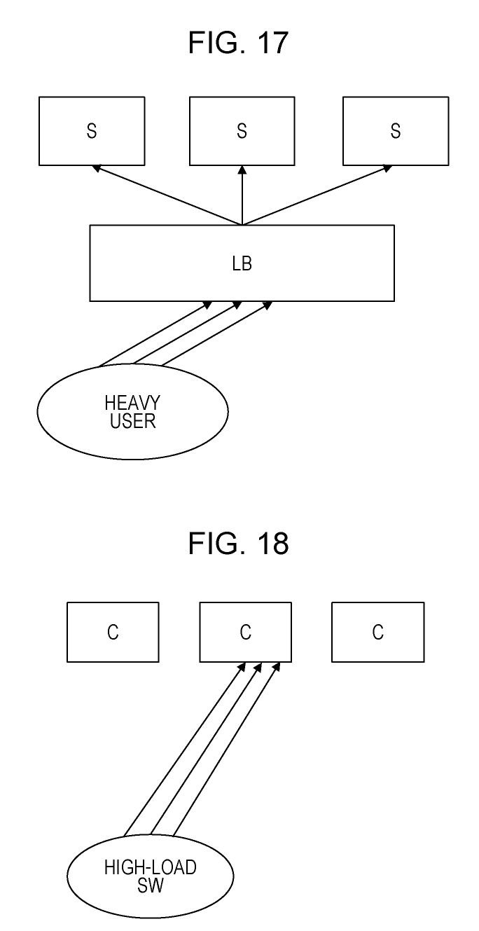

There is a load distribution technique for the “server” as one of the load distribution techniques. In the “server load distribution technique”, loads of multiple service servers (for example, web servers) S are controlled to be distributed by a load balancer LB, as illustrated in FIG. 17, for example.

For example, upon receipt of a request from a user, the load balancer LB determines to which server S the request is to be sent, on the basis of the loads on the respective servers S. Then, the load balancer LB sends the received request to the determined server S. Thus, the processing load corresponding to the user request may be distributed to the multiple servers S.

As the logic for distributing the load to the multiple servers S, a “round-robin method” wherein processing is sequentially handed over to the multiple servers S, a method wherein the number of open sessions is managed for each of the servers S and the processing is handed over to a server S having the minimum number of sessions, and the like are conceivable.

When there is a heavy user who transmits a large volume of requests, the LB equally distributes sessions corresponding to the large volume of requests into the multiple servers S. Therefore, the LB realizes load distribution by equally distributing the sessions into the multiple servers S without identifying which user has transmitted the request.

Now, it is considered that the server load distribution technique as described above is simply applied to a network controller such as the OFC 3. For example, it is considered if the load distribution may be performed by replacing the user with a switch 4 and the multiple servers S with multiple element controllers.

In this case, when an attempt is made to hand over a message to any of the multiple element controllers without identifying which switch 4 has transmitted the message, the correspondence (session) between the switch 4 and the element controllers is to be frequently changed.

When the correspondence is frequently changed, the control becomes complicated and unstable. Therefore, from the viewpoint of stable operation of the network controller, it is not preferable to distribute the messages into different element controllers for each session.

As a result, when there is a specific high load switch (SW) corresponding to the heavy user, as illustrated in FIG. 18, the processing is difficult to be shared by the multiple element controllers (C).

Accordingly, increased load on a specific element controller is inevitable. Therefore, proper load distribution is hardly realized when the server load distribution technique is simply applied to the network controller.

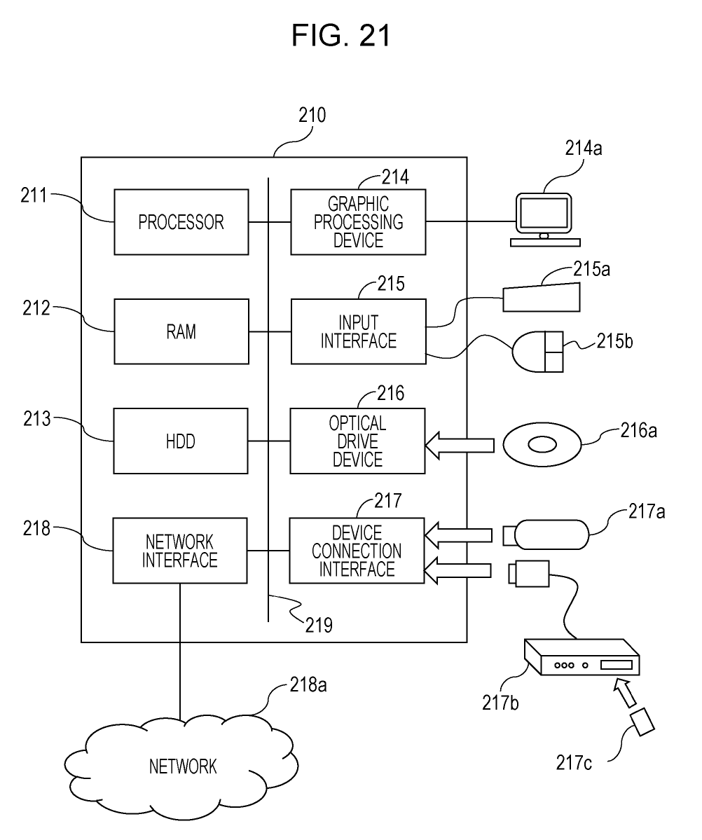

With reference to FIG. 21, description is given of a hardware configuration of a computer 210 which realizes the functions of the controller and the control apparatus for controlling the controller according to the embodiment. FIG. 21 is a diagram illustrating an exemplary hardware configuration.

The computer 210 includes a processor 211, a random access memory (RAM) 212, a hard disk drive (HDD) 213, a graphic processing device 214, an input interface 215, an optical drive device 216, a device connection interface 217, and a network interface 218, for example, as constituent elements. These constituent elements 211 to 218 are communicably connected with each other through a bus 219.

The processor 211 controls the entire computer 210. The processor 211 may be a multiprocessor. The processor 211 may be any one of a CPU, a micro processing unit (MPU), a digital signal processor (DSP), an application specific integrated circuit (ASIC), a programmable logic device (PLD), and a field programmable gate array (FPGA), for example. The processor 211 may be a combination of two or more kinds of the elements selected from the CPU, MPU, DSP, ASIC, PLD, and FPGA.

The RAM 212 is used as a main storage of the computer 210. The RAM 212 temporarily stores therein at least part of programs, such as an operating system (OS) program and application programs, to be executed by the processor 211. The RAM 212 also stores therein various kinds of data used in the processing performed by the processor 211. The application programs may include a program to be executed by the processor 211 so that the computer 210 realizes the functions of the controller and the control apparatus for controlling the controller according to the embodiment.

The HDD 213 magnetically writes and reads data into and from a built-in disk. The HDD 213 is used as an auxiliary storage of the computer 210. The HDD 213 stores therein the OS program, the application programs, and various kinds of data. A semiconductor storage (solid state drive: SSD) such as a flash memory may also be used as the auxiliary storage.

A monitor 214a is connected to the graphic processing device 214. The graphic processing device 214 displays an image on a screen of the monitor 214a in accordance with an instruction from the processor 211. Examples of the monitor 214a include a display device using a cathode ray tube (CRT), a liquid crystal display device, and the like.

A keyboard 215a and a mouse 215b are connected to the input interface 215. The input interface 215 transmits signals received from the keyboard 215a or the mouse 215b to the processor 211. The mouse 215b is an example of a pointing device, and any other pointing device may also be used. Other pointing devices include a touch panel, a tablet, a touch pad, a track ball, and the like.

The optical drive device 216 uses a laser beam or the like to read data recorded on an optical disk 216a. The optical disk 216a is a non-transitory portable recording medium in which data is recorded as readable by reflection of light. Examples of the optical disk 216a include a digital versatile disc (DVD), a DVD-RAM, a compact disc read-only memory (CD-ROM), a CD-R (Recordable)/RW (ReWritable), and the like.

The device connection interface 217 is a communication interface for connecting peripheral devices to the computer 210. A memory device 217a and a memory reader/writer 217b, for example, may be connected to the device connection interface 217. The memory device 217a is a non-transitory recording medium having a communication function of communicating with the device connection interface 217, for example, a universal serial bus (USB) memory. The memory reader/writer 217b writes data into a memory card 217c or reads data from the memory card 217c. The memory card 217c is a non-transitory card-type recording medium.

The network interface 218 is connected to a network 218a. The network interface 218 transmits and receives data to and from another computer or communication device through the network 218a.

The computer 210 having the hardware configuration as described above may realize the functions of the controller and the control apparatus for controlling the controller according to the embodiment.

The computer 210 realizes the functions of the controller and the control apparatus for controlling the controller according to the embodiment by executing a program recorded in a non-transitory computer-readable recording medium, for example. A program describing processing contents to be performed by the computer 210 may be recorded in various recording media. For example, the program to be executed by the computer 210 may be stored in the HDD 213. The processor 211 loads at least part of the program stored in the HDD 213 into the RAM 212, and executes the loaded program.

The program to be executed by the computer 210 (processor 211) may be recorded in a non-transitory portable recording medium such as the optical disk 216a, the memory device 217a, and the memory card 217c. The program stored in the portable recording medium may be executed after being installed into the HDD 213 under the control of the processor 211, for example. The processor 211 may also read the program directly from the portable recording medium and execute the read program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network element controller, comprising:
a processor configured to
control network elements included in a network, the network elements being assigned to the network element controller,
obtain attribute information for the respective network elements, the attribute information indicating a characteristic of throughput depending on communications between the network element controller and the respective network elements, and
select a first network element from the network elements on basis of the obtained attribute information.

2. The network element controller according to claim 1, wherein the processor is configured to
measure signal amounts of signals transmitted and received per unit time between the network element controller and the respective network elements, and
select the first network element using the measured signal amounts as the attribute information.

3. The network element controller according to claim 2, wherein the processor is configured to
determine a second network element having a first signal amount satisfying a first predetermined condition used for determining a relatively large signal amount among the measured signal amounts, and
select the first network element other than the second network element.

4. The network element controller according to claim 3, wherein
the network element controller is one of controllers including a first controller different from the network element controller, and
the processor is configured to
change the first network element to be assigned to the first controller to cause the first network element to be controlled by the first controller, the first controller having a first total signal amount satisfying a second predetermined condition used for determining a relatively small total signal amount, the first total signal amount being a total of signal amounts measured at past for network elements assigned to the first controller.

5. The network element controller according to claim 2, wherein
the network element controller is one of controllers including a first controller different from the network element controller, and
the processor is configured to
select the first network element using the measured signal amounts as the attribute information when a difference in a load between the network element controller and the first controller exceeds a predetermined threshold and a difference in a number of assigned network elements between the controllers is within a predetermined range, the network element controller having a maximum load among the controllers, the first controller having a minimum load among the controllers.

6. The network element controller according to claim 3, wherein
the first predetermined condition is that the first signal amount accounts for a predetermined threshold ratio or more to a total of the signal amounts measured for the respective network elements.

7. The network element controller according to claim 1, wherein
the attribute information indicates whether the respective network elements are positioned at an edge or a core in a network topology of the network.

8. A control apparatus for controlling network element controllers, the control apparatus comprising:
a processor configured to
obtain attribute information for respective network elements included in a network, the respective network elements being assigned to and managed by any one of the network element controllers, the attribute information indicating a characteristic of throughput depending on communications between the respective network element controllers and respective network elements assigned to and controlled by the respective network element controllers, and
control assignment of the network elements to the network element controllers on basis of the obtained attribute information.

9. A method for controlling network element controllers, the method comprising:
obtaining, by a computer, attribute information for respective network elements included in a network, the respective network elements being assigned to and managed by any one of the network element controllers, the attribute information indicating a characteristic of throughput depending on communications between the respective network element controllers and respective network elements assigned to and controlled by the respective network element controllers; and
controlling assignment of the network elements to the network element controllers on basis of the obtained attribute information.
